(19) United States
(12) Patent Application Publication
(10) Pub. No.: US 2026/0197785 A1
(43) Pub. Date: Jul. 9, 2026

(54) TIMING ADVANCE INDICATION IN A RANDOM ACCESS RESPONSE FOR INTER-CELL MULTIPLE TRANSMISSION AND RECEPTION POINT COMMUNICATION

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US); Wooseok NAM, San Diego, CA (US); Yan ZHOU, San Diego, CA (US); Tao LUO, San Diego, CA (US); Peter GAAL, San Diego, CA (US)

(21) Appl. No.: 18/869,082

(22) PCT Filed: Jul. 15, 2022
(86) PCT No.: PCT/CN2022/105923

§ 371 Date: Nov. 25, 2024

(51) Int. Cl. H04W 56/00; H04L 5/00; H04W 74/0833

(52) U.S. Cl. CPC H04W 56/0045; H04L 5/0053; H04W 74/0833

(57) ABSTRACT

Various aspects of the present disclosure generally relate to wireless communication. In some aspects, a user equipment (UE) may transmit a physical random access channel (PRACH) communication associated with an additional physical cell identifier (PCI), the additional PCI being a PCI that is different from a PCI of a serving cell of the UE. The UE may receive a random access response (RAR) message responsive to the PRACH communication associated with the additional PCI, wherein the RAR message indicates timing advance (TA) information associated with the additional PCI. Numerous other aspects are described.

### FIELD OF THE DISCLOSURE

Aspects of the present disclosure generally relate to wireless communication and to techniques and apparatuses for timing advance (TA) indication in a random access response (RAR) for inter-cell multiple transmission and reception point (multi-TRP) communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting a physical random access channel (PRACH) communication associated with an additional physical cell identifier (PCI), the additional PCI being a PCI that is different from a PCI of a serving cell of the UE.

The method may include receiving a random access response (RAR) message responsive to the PRACH communication associated with the additional PCI, where the RAR message indicates timing advance (TA) information associated with the additional PCI.

Some aspects described herein relate to a UE for wireless communication. The user equipment may include a memory and one or more processors coupled to the memory. The one or more processors may be configured to transmit a PRACH communication associated with an additional PCI, the additional PCI being a PCI that is different from a PCI of a serving cell of the UE. The one or more processors may be configured to receive an RAR message responsive to the PRACH communication associated with the additional PCI, where the RAR message indicates TA information associated with the additional PCI.

Some aspects described herein relate to a non-transitory computer-readable medium that stores a set of instructions for wireless communication by a UE. The set of instructions, when executed by one or more processors of the UE, may cause the UE to transmit a PRACH communication associated with an additional PCI, the additional PCI being a PCI that is different from a PCI of a serving cell of the UE. The set of instructions, when executed by one or more processors of the UE, may cause the UE to receive an RAR message responsive to the PRACH communication associated with the additional PCI, where the RAR message indicates TA information associated with the additional PCI.

Some aspects described herein relate to an apparatus for wireless communication. The apparatus may include means for transmitting a PRACH communication associated with an additional PCI, the additional PCI being a PCI that is different from a PCI of a serving cell of the apparatus. The apparatus may include means for receiving an RAR message responsive to the PRACH communication associated with the additional PCI, where the RAR message indicates TA information associated with the additional PCI.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed RAN, in accordance with the present disclosure.

FIG. 5 is a diagram illustrating an example of multiple transmission and reception point (multi-TRP) communication, in accordance with the present disclosure.

FIG. 6 is a diagram illustrating an example of TRP differentiation at a UE based at least in part on a control resource set (CORESET) pool index, in accordance with the present disclosure.

FIG. 7 is a diagram illustrating an example of downlink and uplink transmissions between a network node and a UE in a wireless network, in accordance with the present disclosure.

FIGS. 8A and 8B are diagrams illustrating examples associated with timing advance (TA) indication in a random access response (RAR) for inter-cell multi-TRP communication, in accordance with the present disclosure.

FIG. 9 is a diagram illustrating an example process performed, for example, by a UE, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

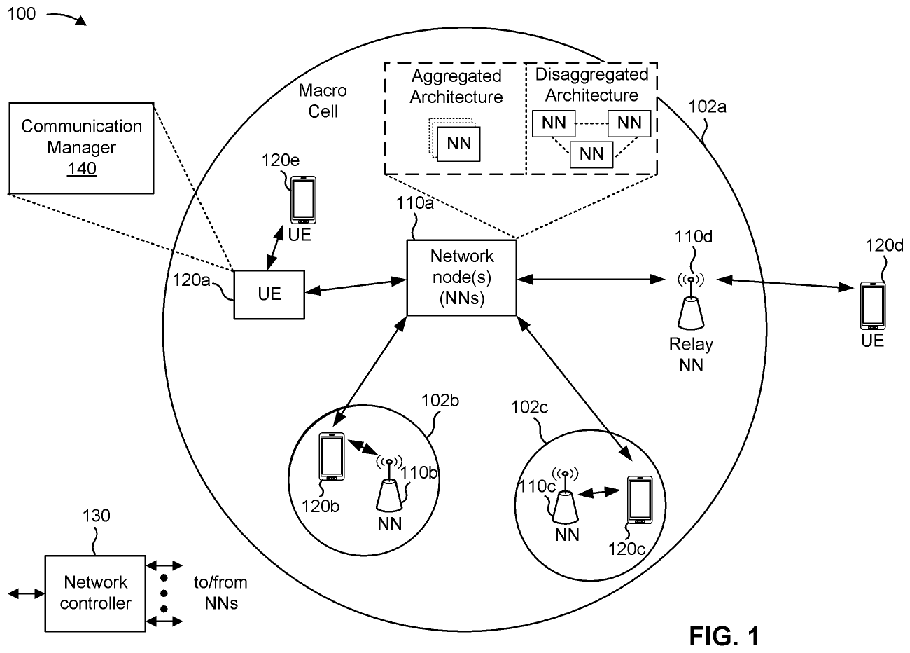

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHZ). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit a physical random access channel (PRACH) communication associated with an additional physical cell identifier (PCI), the additional PCI being a PCI that is different from a PCI of a serving cell of the UE; and receive a random access response (RAR) message responsive to the PRACH communication associated with the additional PCI, wherein the RAR message indicates timing advance (TA) information associated with the additional PCI. Additionally, or alternatively, the communication manager 140 may perform one or more other operations described herein.

As indicated above, FIG. 1 is provided as an example. Other examples may differ from what is described with regard to FIG. 1.

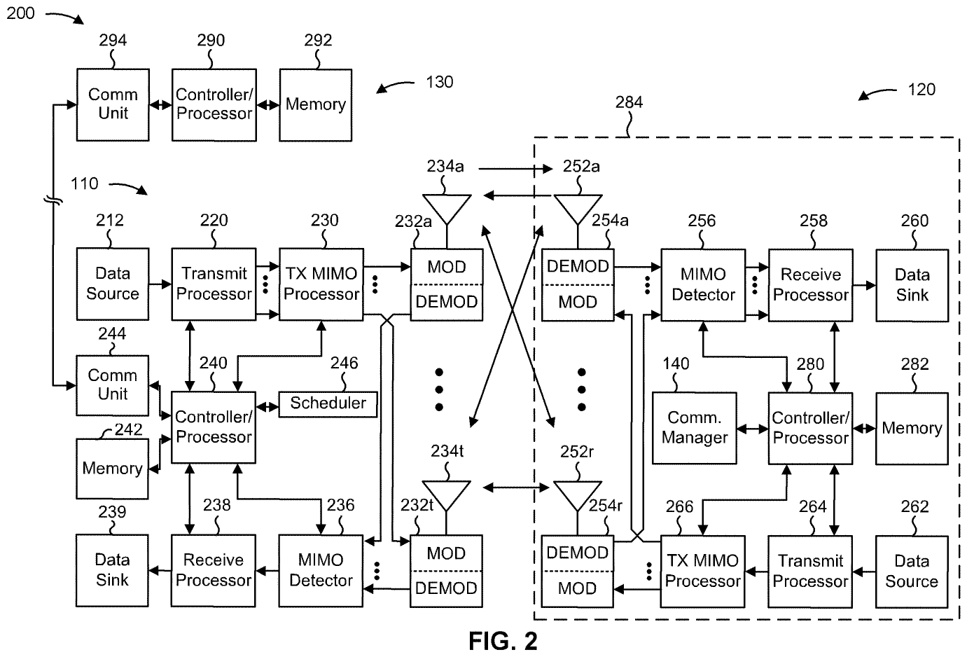

FIG. 2 is a diagram illustrating an example 200 of a network node 110 in communication with a user equipment (UE) 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node.

Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

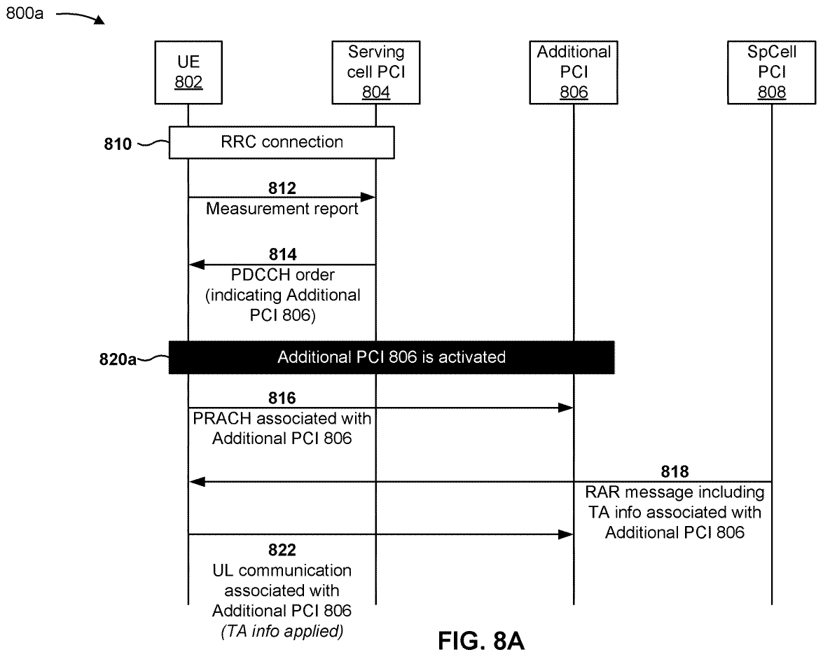

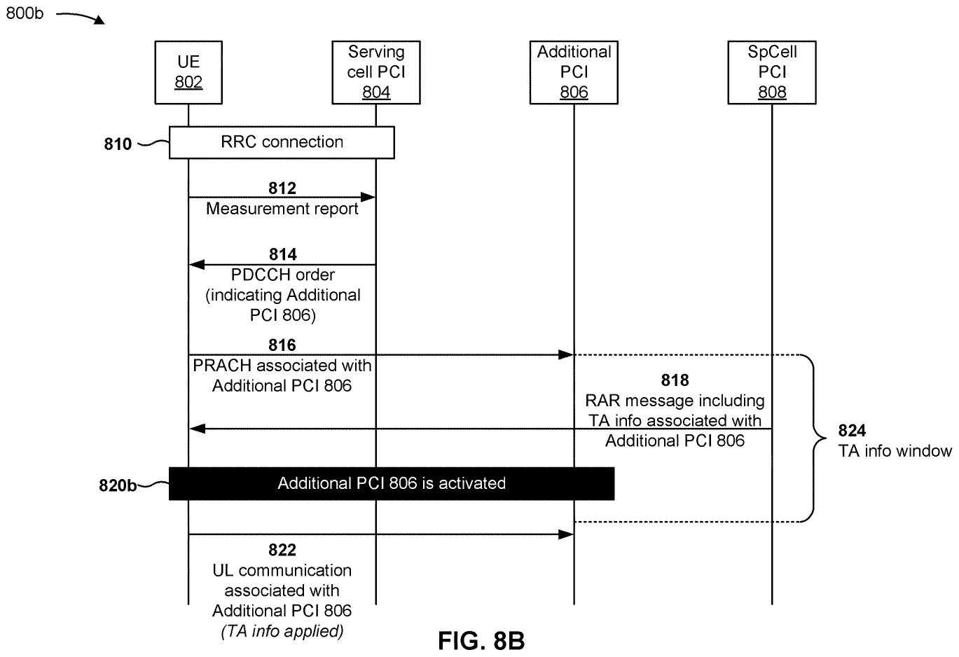

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8A-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8A-10).

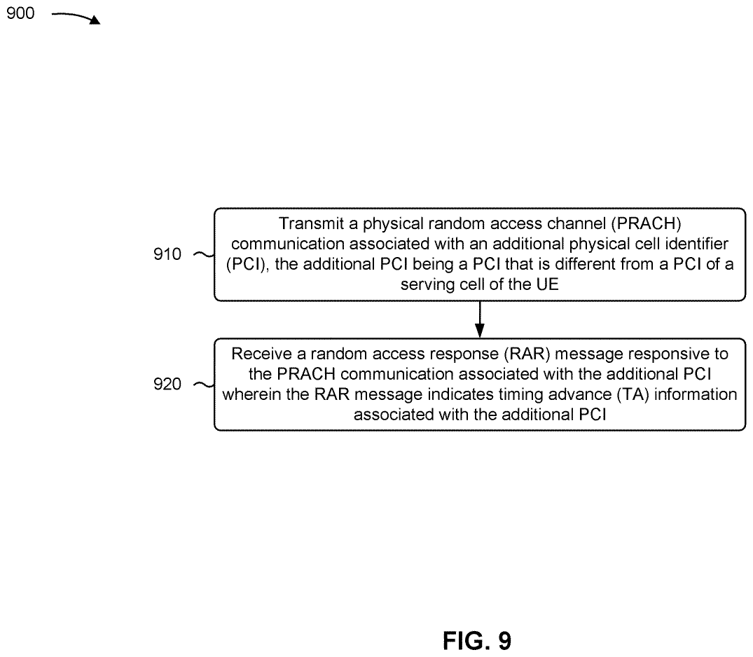

The controller/processor 240 of the network node 110, the controller/processor 280 of the UE 120, and/or any other component(s) of FIG. 2 may perform one or more techniques associated with TA indication in an RAR for inter-cell multi-TRP communication, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, and/or other processes as described herein. In some examples, executing instructions may include running the instructions, converting the instructions, compiling the instructions, and/or interpreting the instructions, among other examples.

In some aspects, the UE (e.g., a UE 120) includes means for transmitting a PRACH communication associated with an additional PCI, the additional PCI being a PCI that is different from a PCI of a serving cell of the UE; and/or means for receiving an RAR message responsive to the PRACH communication associated with the additional PCI, wherein the RAR message indicates TA information associated with the additional PCI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

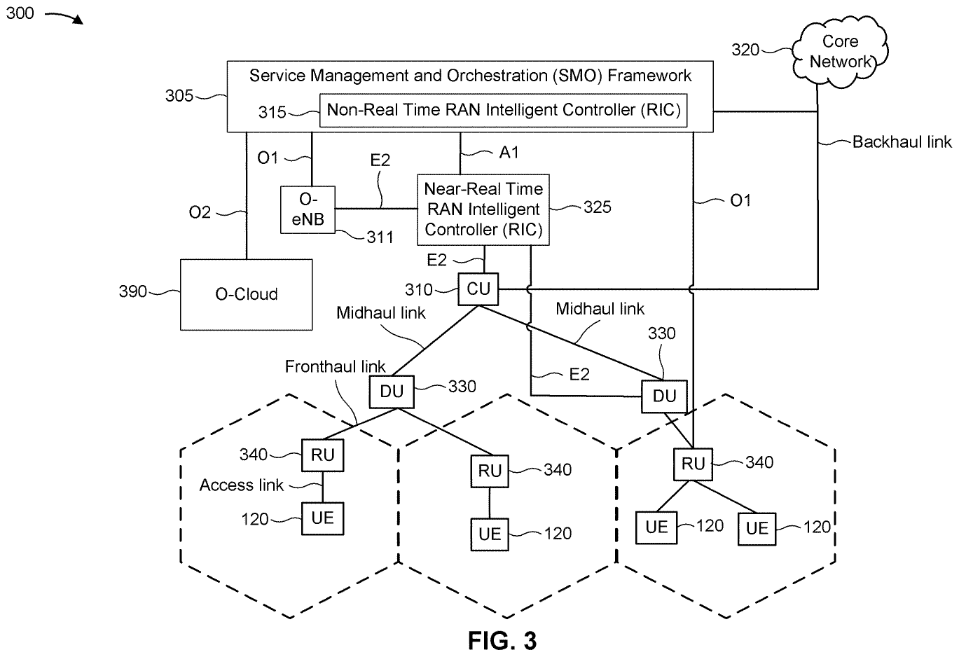

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective Ol interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325.

The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

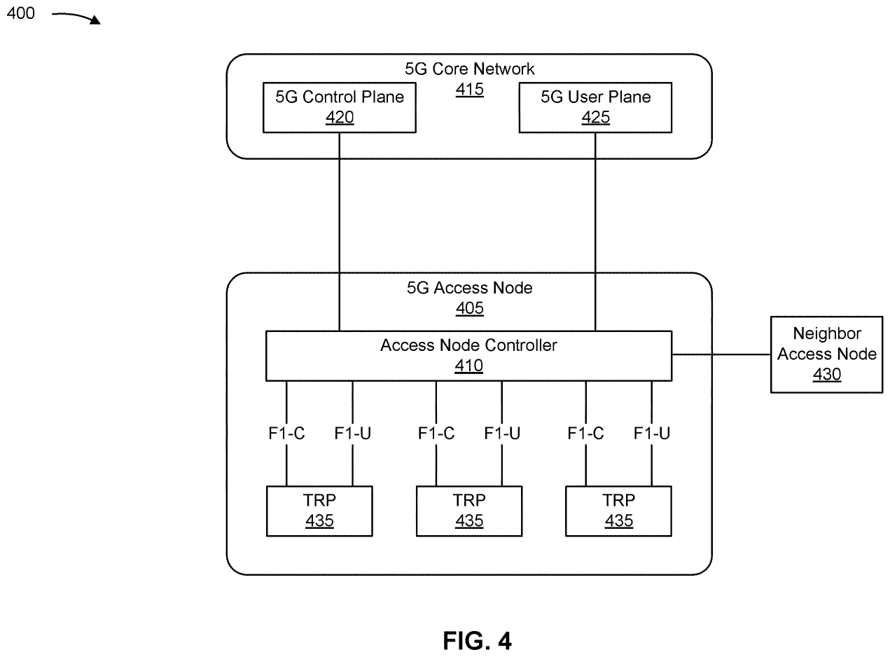

FIG. 4 illustrates an example logical architecture of a distributed RAN 400, in accordance with the present disclosure.

A 5G access node 405 may include an access node controller 410. The access node controller 410 may be a central unit (CU) of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a distributed unit (DU) of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a packet data convergence protocol (PDCP) layer, a radio link control (RLC) layer, and/or a medium access control (MAC) layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different QCL relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

In some aspects, the logical architecture of the distributed RAN 400 described in association with FIG. 4 may be used to support TA indication in an RAR for inter-cell multi-TRP communication, as described herein.

As indicated above, FIG. 4 is provided as an example. Other examples may differ from what was described with regard to FIG. 4.

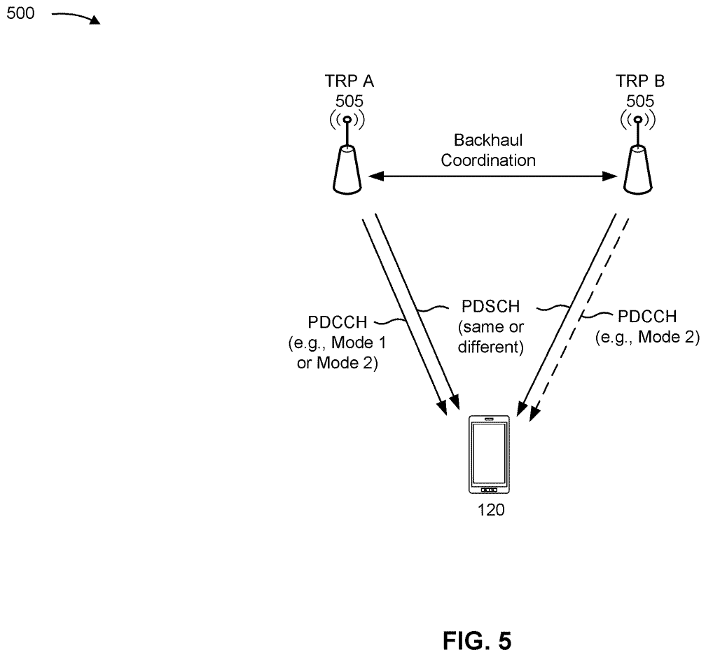

FIG. 5 is a diagram illustrating an example 500 of multi-TRP communication (sometimes referred to as multi-panel communication or mTRP communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110 110. The different TRPs 505 may communicate with the UE 120 using different QCL relationships (e.g., different TCI states), different demodulation reference signal (DMRS) ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

In some aspects, the techniques and apparatuses associated with TA indication in an RAR for inter-cell multi-TRP communication described herein can be used in conjunction with multi-TRP communication as described in association with FIG. 5.

As indicated above, FIG. 5 is provided as an example. Other examples may differ from what is described with respect to FIG. 5.

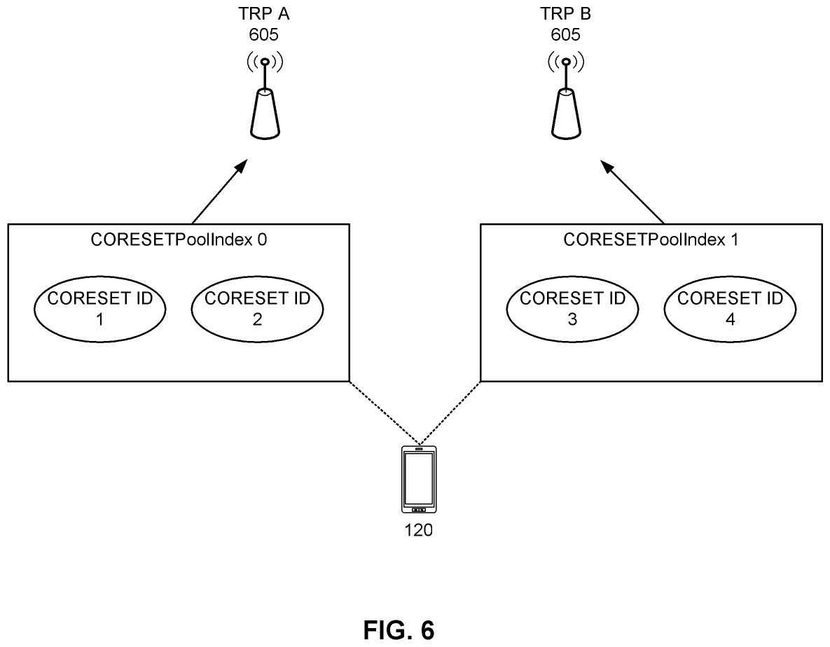

FIG. 6 is a diagram illustrating an example of TRP differentiation at a UE based at least in part on a CORESET pool index, in accordance with the present disclosure. In some aspects, a CORESET pool index (or CORESETPoolIndex) value may be used by a UE (e.g., a UE 120) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 6, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 6, two or more (e.g., up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 605. As an example, and as illustrated in FIG. 6, a first TRP 605 (TRP A) may be associated with CORESET pool index 0 and a second TRP 605 (TRP B) may be associated with CORESET pool index 1. The UE 120 may be configured by a higher layer parameter, such as PDCCH-Config, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

In some aspects, TRP differentiation at a UE based at least in part on a CORESET pool index can be utilized in conjunction with the techniques and apparatuses for TA indication in an RAR for inter-cell multi-TRP communication as described herein.

As indicated above, FIG. 6 is provided as an example. Other examples may differ from what is described with respect to FIG. 6.

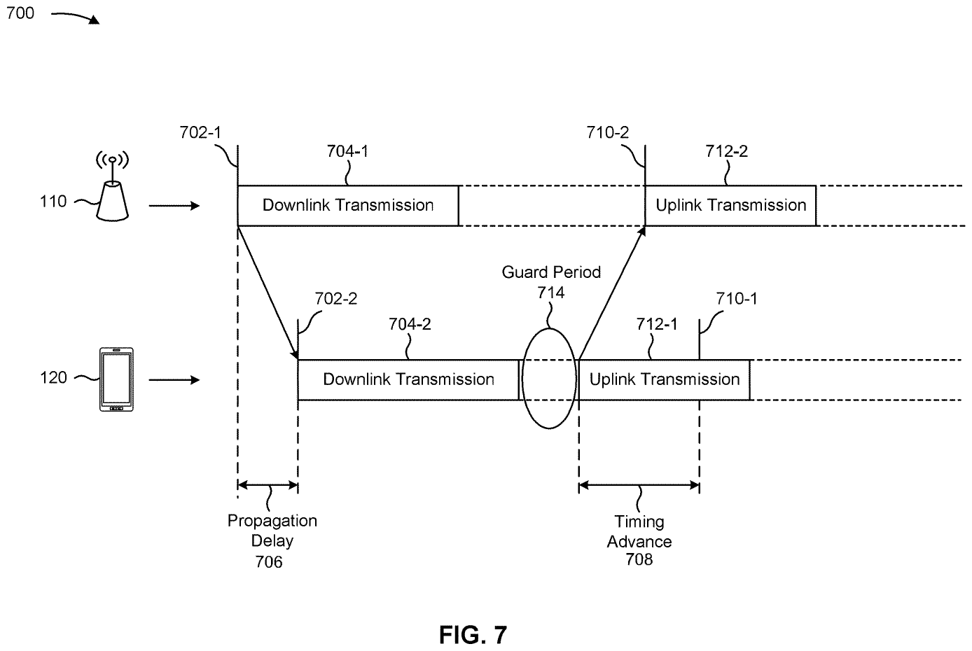

FIG. 7 is a diagram illustrating an example 700 of downlink and uplink transmissions between a network node 110 and a UE 120 in a wireless network 100, in accordance with the present disclosure. In some examples, the downlink and/or uplink transmissions are based at least in part on a TA and/or a guard period between communications. As one example, a network node 110 may configure a downlink transmission to end before the start of a guard period. As another example, the UE 120 may advance a start time for an uplink transmission based at least in part on a TA.

As shown by reference number 702-1, a network node 110 may begin a downlink transmission 704-1 to a UE 120 at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (ms)). Each radio frame may be further partitioned into a set of Z (Z≥1) subframes, where each subframe may have a predetermined duration (e.g., 1 ms). Each subframe may be further partitioned into a set of slots and/or each slot may include a set of L symbol periods (e.g., fourteen symbol periods, seven symbol periods, or another number of symbol periods). Thus, the first point in time as shown by the reference number 702-1 may be based at least in part on a time partition as defined by a telecommunication system (e.g., a frame, a subframe, a slot, a mini-slot, and/or a symbol).

In some examples, the network node 110 and the UE 120 may wirelessly communicate with one another (e.g., directly or via one or more network nodes) based at least in part on the defined time partitions. However, each device may have different timing references for the time partitions. To illustrate, and as shown by the reference number 702-1, the network node 110 may begin the downlink transmission 704-1 at a particular point in time that may be associated with a defined time partition based at least in part on a time perspective of the network node 110. For example, the network node 110 may associate the particular point in time with a defined time partition, such as a beginning of a symbol, a beginning of a slot, a beginning of a subframe, and/or a beginning of a frame. However, the downlink transmission may incur a propagation delay 706 in time, such as a time delay based at least in part on the downlink transmission traveling between a network node 110 (e.g., an RU) and the UE 120. As shown by reference number 702-2, the UE 120 may receive downlink transmission 704-2 (corresponding to downlink transmission 704-1 transmitted by the network node 110) at a second point in time that is later in time relative to the first point in time. From a time perspective of the UE 120, however, the UE 120 may associate the second point in physical time shown by the reference number 702-2 with the same particular point in time of the defined time partition as the network node 110 (e.g., a beginning of the same symbol, a beginning of the same mini-slot, a beginning of the same slot, a beginning of the same subframe, and/or a beginning of the same frame). Thus, as shown by the example 700, the time perspective of the UE 120 may be delayed in time from the time perspective of the network node 110.

In wireless communication technologies like 4G/LTE and 5G/NR, a TA value is used to control a timing of uplink transmissions by a UE (e.g., UE 120 and/or the like) such that the uplink transmissions are received by a network node 110 (e.g., an RU) at a time that aligns with an internal timing of the network node 110. A network node 110 may determine the TA value to a UE (e.g., directly or via one or more network nodes) by measuring a time difference between reception of uplink transmissions from the UE and a subframe timing used by the network node 110 (e.g., by determining a difference between when the uplink transmissions were supposed to have been received by the network node 110, according to the subframe timing, and when the uplink transmissions were actually received). The network node 110 may transmit a TA command (TAC) to instruct the UE to transmit future uplink communications earlier or later to reduce or eliminate the time difference and align timing between the UE and network node 110. The TA command is used to offset timing differences between the UE and the network node 110 due to different propagation delays that occur when the UE is different distances from the network node 110. If TA commands were not used, then uplink transmissions from different UEs (e.g., located at different distances from the network node 110) may collide due to mistiming even if the uplink transmissions are scheduled for different subframes.

To illustrate, without adjusting a start time of an uplink transmission, the UE 120 may be configured to begin an uplink transmission at a scheduled point in time based at least in part on the defined time partitions as described elsewhere herein. As shown by reference number 710-1, a start of the scheduled point in time may occur at a third physical point in time based at least in part on the timing perspective of the UE 120. However, and as shown by reference number 710-2, the scheduled point in time with reference to the timing perspective of the network node 110 (e.g., an RU) may occur at a fourth point in physical time that occurs before the third point in physical time as shown by the reference number 710-1. Accordingly, the network node 110 may instruct the UE 120 (e.g., directly or via one or more network nodes) to apply a timing advance 708 to an uplink transmission to better align reception of the uplink transmission with the timing perspective of the network node 110. However, in some examples, the fourth point in time shown by the reference number 710-2 may occur at or near a same physical point in time as the third point in time shown by the reference number 710-1 such that uplink transmissions from the UE 120 to the network node 110 incur the propagation delay 706. In such a scenario, the network node 110 may instruct the UE 120 to apply a timing advance with a time duration corresponding to the propagation delay 706.

As shown by the example 700, the UE 120 may adjust a start time of an uplink transmission 712-1 based at least in part on the timing advance 708 and the start of the scheduled point in time (e.g., at the third physical point in time shown by the reference number 710-1). Based at least in part on propagation delay, the network node 110 may receive an uplink transmission 712-2 (corresponding to the uplink transmission 712-1 transmitted by the UE 120) at the fourth point in physical time shown by the reference number 710-2.

In some examples, a timing advance value may be based at least in part on twice an estimated propagation delay (e.g., the propagation delay 706) and/or may be based at least in part on a round trip time (RTT). A network node 110 (e.g., a DU or a CU) may estimate the propagation delay and/or select a timing advance value based at least in part on communications with the UE 120. As one example, the network node 110 may estimate the propagation delay based at least in part on a network access request message from the UE 120. Additionally, or alternatively, the network node 110 may estimate and/or select the timing advance value from a set of fixed timing advance values.

In some examples, a telecommunication system and/or telecommunication standards may define a guard period 714 (e.g., a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 714 may sometimes be referred to as a gap, a switching guard period, or a guard interval.

In some examples, a network node 110 (e.g., a DU or a CU) may select a starting transmission time and/or a transmission time duration based at least in part on a receiving device and/or the guard period. For example, the network node 110 may select an amount of content (e.g., data and/or control information) to transmit in the downlink transmission 704-1 based at least in part on beginning the transmission at the first point in time shown by the reference number 702-1 and/or the UE 120 completing reception of the downlink transmission 704-2 prior to a starting point of the guard period 714. Alternatively, or additionally, the UE 120 may select an amount of content (e.g., data and/or control information) to transmit in the uplink transmission 712-1 based at least in part on the timing advance 708, the third point in time shown by the reference number 710-1, and/or refraining from beginning the uplink transmission 712-1 until the guard period 714 has ended.

In some aspects, the techniques and apparatuses associated with TA indication in an RAR for inter-cell multi-TRP communication described herein may be applied in association with a TA as described in association with FIG. 7.

As indicated above, FIG. 7 is provided as an example. Other examples may differ from what is described with regard to FIG. 7.

As described above, multi-TRP communication enables a UE to communicate with multiple (different) TRPs. In practice, different TRPs communicating with the same UE can be associated with the same physical cell identifier (PCI) or with different PCIs. Multi-TRP communication when different TRPs communicating with the same UE are associated with the same PCI is referred to as intra-cell multi-TRP communication. Multi-TRP communication when different TRPs communicating with the same UE are associated with different PCIs is referred to as inter-cell multi-TRP communication. Notably, in the case of inter-cell multi-TRP communication, from the perspective of the UE, multi-TRP communication is defined in a serving cell of the UE, and the UE is aware of one only one PCI-the PCI associated with the serving cell (e.g., the cell acquired during a cell search).

With respect to inter-cell multi-TRP communication, a maximum quantity of additional PCIs (e.g., PCIs other than a PCI of the serving cell) per component carrier, denoted as X, can be reported as a UE capability. A UE may support two independent values of X−X1 and X2—which can be reported as a UE capability for two different assumptions on additional synchronization signal block (SSB) time domain position and periodicity with respect to an SSB of the serving cell. Here, the value of X1 represents a maximum quantity of additional PCIs that can be configured when each configuration of SSB time domain positions and periodicity of additional PCIs is assumed to be the same as that of the SSB of the serving cell. Conversely, the value of X2 represents a maximum quantity of additional PCIs that can be configured when configurations of the SSB time domain positions and periodicity of additional PCIs is not assumed to be the same as that of the SSB of the serving cell. By definition, scenarios supporting the use of X1 and X2 cannot occur simultaneously. Additional PCIs can be configured via RRC signaling and, from an RRC signal perspective, a quantity of additional PCIs that can be configured can be from one to seven. Further, for inter-cell multi TRP operation, a center frequency, a subcarrier spacing (SCS), and a system frame number (SFN) offset are assumed to be the same for SSBs of the serving cell and configured SSBs with PCIs different from the serving cell. In some aspects, an indicator (e.g., provided via RRC signaling) can be used to indicate non-serving cell information that a TCI state/QCL information is associated with. Here, the indicator may be different from the value of the PCI.

A UE can be configured (e.g., via RRC signaling) with up to M (e.g., M=128) candidate transmission configuration indicator (TCI) states at least for the purposes of quasi co-location (QCL) indication. Notably, while these TCI states are configured in a PDSCH configuration (e.g., PDSCH-Config), a given TCI state (e.g., associated with a given TCI-StateId) can be used to configure a TCI state for a type of resource other than a PDSCH resource, such as a CORESET, a non-zero-power channel state information reference signal (NZP-CSI-RS) resource, a physical uplink control channel (PUCCH) resource, or a sounding reference signal (SRS) resource, among other examples. For PDSCH, a MAC control element (MAC-CE) can be used to activate up to 2^{N} TCI states out of the M configured TCI states for QCL indication for a given CORESET pool index (e.g., CORESETPoolIndex). Here, N (e.g., N=3) bits carried in DCI can be used to dynamically indicate a TCI state, of the activated TCI states, to be used in association with a PDSCH communication. For PDCCH, a MAC-CE can be used to activate one TCI state of the M configured TCI states. Notably, for multi-DCI based multi-TRP communication, the PDSCH is associated with a CORESET pool index of a CORESET in which the DCI indicating the TCI state is received.

Further, a PCI can be associated with a CORESET pool index. A PCI of the serving cell is always associated with active TCI states, and only one additional PCI can be associated with the active TCI states. For inter-cell multi-TRP, one PCI associated with one or more activated TCI states (for PDSCH/PDCCH reception) is associated with one CORESET pool index, and another PCI associated with one or more activated TCI states (for PDSCH/PDCCH reception) is associated with another CORESET pool index.

In some wireless communication systems, two TAs for uplink multi-DCI based multi-TRP communication may be specified. In such a scenario, different TRPs may have different TA values. For inter-cell multi-DCI multi-TRP communication, a UE and a network node need knowledge of an uplink TA to be used for transmitting an uplink communication associated with a TRP that is associated with an additional PCI (e.g., a PCI that is different from a PCI of a serving cell of the UE).

Some aspects described herein provide techniques and apparatuses for TA indication in an RAR for inter-cell multi-TRP communication. In some aspects, a UE may transmit a physical random access channel (PRACH) communication associated with an additional PCI (e.g., a PCI that is different from a PCI of a serving cell of the UE). The UE may then receive a RAR message responsive to the PRACH communication associated with the additional PCI, where the RAR message indicates TA information associated with the additional PCI. In this way, a UE and a network node may have knowledge of an uplink TA that can be used for transmitting an uplink communication associated with a TRP that is associated with the additional PCI, thereby improving reliability and performance of inter-cell multi-TRP communication. Additional details are provided below.

FIGS. 8A and 8B are diagrams illustrating examples 800a and 800b, respectively, associated with TA indication in an RAR for inter-cell multi-TRP communication, in accordance with the present disclosure. As shown in FIGS. 8A and 8B, examples 800a and 800b includes communication between a UE 802, a serving cell PCI 804, an additional PCI 806, and a special cell (SpCell) PCI 808. In some aspects, the UE 802, the serving cell PCI 804, the additional PCI 806, and the SpCell PCI 808 may be included in a wireless network, such as wireless network 100. The UE 802, the serving cell PCI 804, the additional PCI 806, or the SpCell PCI 808 may communicate via one or more wireless access links (which may include an uplink and a downlink) or one or more backhaul links.

The UE 802 may correspond to a UE 120 or one or more other wireless communication devices described herein.

The serving cell PCI 804 may correspond to a serving cell of the UE 120. In some aspects, the serving cell may be a special cell (SpCell) of the UE 120 (e.g., a primary cell (Pcell) of the UE 120 or a primary secondary cell (PScell) of the UE 120) or a secondary cell (Scell) of the UE 120. In some aspects, the serving cell PCI 804 may correspond to a cell supported by one or more network nodes 110, one or more TRPs 435, one or more TRPs 505, one or more TRP 606, or one or more other wireless communication devices described herein.

The additional PCI 806 may correspond to a cell having a PCI different from a PCI of the serving cell of the UE 802. In some aspects, the additional PCI 806 may be configured in an SpCell of the UE 802 or in an Scell of the UE 802. In some aspects, the additional PCI 806 may correspond to a cell supported by one or more network nodes 110, one or more TRPs 435, one or more TRPs 505, one or more TRP 606, or one or more other wireless communication devices described herein.

The SpCell PCI 808 may correspond to an SpCell of the UE 802. The SpCell of the UE 802 may be, for example, a Pcell of the UE 802 or a PScell of the UE 802. In some aspects, the SpCell PCI 808 may correspond to a cell supported by one or more network nodes 110, one or more TRPs 435, one or more TRPs 505, one or more TRP 606, or one or more other wireless communication devices described herein. In some aspects, if the serving cell of the UE 802 is the SpCell of the UE 802, then the serving cell PCI 804 may be the same as the SpCell PCI 808.

FIG. 8A illustrates the example 800a in which the additional PCI 806 is activated at a time that the UE 802 transmits a PRACH communication associated with the additional PCI 806.

As shown in FIG. 8A by reference 810, the UE 802 and the serving cell PCI 804 may establish an RRC connection. That is, the UE 802 and a TRP associated with a serving cell of the UE 802 (e.g., a TRP that supports the serving cell of the UE 802, which corresponds to the serving cell PCI 804) may establish an RRC connection.

As shown by reference 812, after establishment of the RRC connection, the UE 802 may transmit, and the serving cell PCI 804 may receive, a measurement report. That is, the UE 802 may perform one or more measurements based at least in part on an SSB configuration associated with the serving cell and one or more additional PCIs (e.g., non-serving cells) of the UE 802, and may report results (e.g., one or more layer 1 (L1) RSRP values) of the one or more measurements to the TRP associated with the serving cell.

As shown by reference 814, the serving cell PCI 804 may transmit, and the UE 802 may receive, a PDCCH order, where the PDCCH order indicates a PRACH configuration associated with the additional PCI 806. For example, the TRP associated with the serving cell of the UE 802 may determine, based at least in part on the measurement report, that the additional PCI 806 is to be configured or activated for the UE 802. In some aspects, the serving cell PCI 804 may trigger contention free random access (CFRA) for the additional PCI 806 by transmitting, to the UE 802, a PDCCH order indicating the PRACH configuration associated with the additional PCI 806.

As shown by reference 816, the UE 802 may transmit, and the additional PCI 806 may receive, a PRACH communication associated with the additional PCI 806. That is, the UE 802 may transmit, and a TRP corresponding to the additional PCI 806 may receive, a PRACH communication associated with the additional PCI 806. In some aspects, the UE 802 transmits the PRACH communication based at least in part on the PDCCH order. That is, in some aspects, the PDCCH order may trigger the UE 802 to provide the PRACH communication associated with the additional PCI 806.

As shown by reference 818, the SpCell 808 may transmit, and the UE 802 may receive, an RAR message responsive to the PRACH communication associated with the additional PCI. That is, a TRP that supports the SpCell corresponding to the SpCell PCI 808 may transmit, and the UE 802 may receive, an RAR message responsive to the PRACH communication associated with the additional PCI 806.

In some aspects, the RAR message indicates TA information associated with the additional PCI 806. For example, the RAR message may indicate TA information (e.g., a TA value, a TA command, or the like) associated with the additional PCI 806. In some aspects, the TA information indicates a TA to be applied for an uplink communication associated with the additional PCI 806.

In example 800a, as shown by reference 820a, the additional PCI 806 is activated prior to the UE 802 transmitting the PRACH communication associated with the additional PCI 806. That is, in example 800a, the additional PCI 806 is associated with one or more active TCI states before the PRACH communication. Put another way, the additional PCI 806 is active at the time at which the PRACH communication associated with the additional PCI 806 is transmitted by the UE 802.

In some aspects, based at least in part on the additional PCI 806 being associated with one or more active TCI states at the time of of the transmission of the PRACH communication associated with the additional PCI 806, the UE 802 may apply the TA information in association with transmitting an uplink communication. For example, as shown by reference 822, the UE 802 may apply the TA information for a processing timeline after receiving the RAR message indicating the TA information such that the UE 802 applies the TA information to an uplink communication transmitted by the UE 802.

FIG. 8B illustrates the example 800b in which the additional PCI 806 is not activated at a time that the UE 802 transmits a PRACH communication associated with the additional PCI 806. Operations associated with references 810, 812, 814, 816, and 818 as shown in example 800b may be similar to those described above in association with example 800a.

However, in example 800b, as shown by reference 820b, the additional PCI 806 is not activated prior to the UE 802 transmitting the PRACH communication associated with the additional PCI 806. That is, in example 800b, the additional PCI 806 is not associated with one or more active TCI states at the time at which the UE 802transmits the PRACH communication.

In some aspects, if the additional PCI 806 is not associated with any active TCI state, then the UE 802 may store the TA information indicated in the RAR message. In some aspects, the UE 802 may store the TA information for a period of time defined by a TA information window 824. The TA information window 824 corresponds to a period of time during which the UE 802 is valid. In some aspects, the UE 802 may determine that the TA information has expired once the TA information window 824 has lapsed. That is, the UE 802 may drop the TA information upon determining that the TA information window has lapsed.

For example, in example 800b, the UE 802 may determine, based at least in part on the TA information window 824, that the TA information has not expired at the time at which the additional PCI 806 is activated. In this scenario, as shown by reference 820b, the additional PCI 806 is activated prior to the end of the TA information window 824. That is, the additional PCI 806 is associated with one or more active TCI states within the TA information window 824 (i.e., before expiration of the TA information). Thus, as shown by reference 822, the UE 802 may apply the TA information for a processing timeline after receiving the RAR message indicating the TA information such that the UE 802 applies the TA information to an uplink communication transmitted by the UE 802.

In some aspects, the UE 802 may determine that the TA information has expired based at least in part on the TA information window 824. That is, the UE 802 may determine that the TA information has expired without the additional PCI 806 being activated. In this scenario, the additional PCI 806 is not activated prior to the end of the TA information window 824. In some aspects, the UE 802 may drop the TA information based at least in part on determining that the additional PCI 806 is not associated with any active TCI state before the TA information expires.

In some aspects, a start of the TA information window 824 is at an end of the PRACH communication associated with the additional PCI 806. Additionally, or alternatively, the start of the TA information window 824 is at an end of reception of the RAR message (e.g., an end of the RAR PDSCH reception). In some aspects, a duration of the TA information window 824 is preconfigured on the UE 802 according to a wireless communication standard. In some aspects, the duration of the TA information window 824 is configured on the UE 802 by a network node (e.g., a network node 110).

In some aspects, the UE 802 may transmit UE capability information indicating a maximum quantity of items of TA information that can be stored by the UE 802 for a single cell. Additionally, or alternatively, the UE 802 may transmit UE capability information indicating a maximum quantity of items of TA information that can be stored by the UE 802 for multiple cells.

Notably, for RAR messaging, a Type-1 common search space (CSS) may be configured only in an SpCell of the UE 802 and, therefore, the RAR message is transmitted from the SpCell. In addition, the UE 802 may not be configured to monitor the Type-1 CSS when an active TCI state is associated with the additional PCI 806. Therefore, some inter-TRP coordination is needed so that the TA information (measured in a TRP associated with the additional PCI 806) can be obtained by the SpCell. In some aspects, after receiving the PRACH communication, the additional PCI 806 (e.g., the TRP supporting the cell corresponding to the additional PCI 806) may transmit the TA information associated with the additional PCI 806 to the SpCell PCI 808 (e.g., the TRP supporting the SpCell of the UE 802). Therefore, in some aspects, as shown in examples 800a and 800b, the SpCell PCI 808 may transmit, and the UE 802 may receive, the RAR message on the SpCell of the UE 802. In some aspects, the SpCell of the UE 802 may be a Pcell of the UE 802 or a PScell of the UE 802.

With respect to RAR monitoring performed by the UE 802 (e.g., monitoring performed in association with receiving the RAR message including the TA), an RAR monitoring window may start at a first symbol of an earliest CORESET in which the UE 802 is configured to receive PDCCH communications for a Type-1 PDCCH CSS set that is at least one symbol after a last symbol of a PRACH occasion corresponding to the PRACH communication transmitted by the UE 802. Here, a symbol duration may correspond to an SCS for the Type-1 PDCCH CSS set. Such an RAR monitoring window is herein referred to as a first RAR monitoring window. However, for non-ideal backhaul, inter-TRP coordination may require some amount of delay, meaning that some amount of delay may be needed between the PRACH communication and the Type-1 PDCCH communication that is provided on the SpCell.

Thus, in some aspects, the UE 802 may be configured such that a start of an RAR monitoring window is at a first symbol of an earliest CORESET that is at least a particular amount of time after an end of a PRACH occasion corresponding to the PRACH communication associated with the additional PCI 806. Such an RAR monitoring window is herein referred to as a second RAR monitoring window. In some aspects, the particular amount of time corresponds to a particular quantity of symbols, a particular quantity of slots, or a particular quantity of milliseconds. In some aspects, the particular amount of time is configured per additional PCI 806. In some aspects, the particular amount of time is associated with multiple additional PCIs 806. In some aspects, a duration of the RAR monitoring window is configured per additional PCI.

In some aspects, the UE 802 may perform monitoring during the second RAR monitoring window (e.g., the UE 802 may refrain from performing RAR monitoring in a legacy RAR monitoring window (e.g., the first RAR monitoring window)).

In some aspects, the UE 802 may perform monitoring during both the first RAR monitoring window and the second RAR monitoring window (e.g., the UE 802 may perform RAR monitoring in the legacy RAR monitoring window and the RAR monitoring window that includes some amount of delay, as described above).

In some aspects, the UE 802 may perform monitoring during the first RAR monitoring window, and may selectively perform monitoring during the second RAR monitoring window based at least in part on a result of monitoring during the first RAR monitoring window. For example, the UE 802 may perform monitoring during the first monitoring window. Here, if a PDCCH communication scrambled by a random access radio network temporary identifier (RA-RNTI) associated with a PRACH occasion corresponding to the PRACH communication is not detected by the UE 802 during the first RAR monitoring window, then the UE 802 may perform monitoring during the second RAR window. Conversely, if a PDCCH communication scrambled by the RA-RNTI associated with the PRACH occasion corresponding to the PRACH communication is detected by the UE 802 during the first RAR monitoring window, then the UE 802 may refrain from performing monitoring during the second RAR window. In some aspects, the UE 802 may transmit UE capability information indicating whether monitoring for the RAR message in multiple RAR monitoring windows is supported by the UE 802.

In some aspects, as described above, the additional PCI 806 may be active at a time at which the UE 802 transmits the PRACH communication associated with the additional PCI 806. In addition, the additional PCI 806 may in some aspects be configured on the SpCell PCI 808. In such a scenario, the PDCCH order may be transmitted after a TCI state associated with the additional PCI 806 is activated (i.e., after the additional PCI 806 activated), then the PDCCH order can be transmitted in a CORESET when the active TCI state is associated with the additional PCI 806 (i.e., the PDCCH order can be transmitted from the additional PCI 806). However, the UE 802 may not be configured to monitor Type-1 CSS when the active TCI state is associated with an additional PCI. Under such a condition, to indicate the TA information associated with the additional PCI 806, the RAR message could be transmitted from the SpCell (e.g., the cell corresponding to the SpCell PCI 808). Here, if CFRA is triggered on the SpCell (i.e., when the PDCCH order is transmitted from an additional PCI configured on SpCell), then (1) DMRS QCL properties of the PDCCH order do not match DMRS QCL properties of a PDCCH associated with the RAR message (e.g., a PDCCH that includes DCI format 1_0 with a cyclic redundancy check (CRC) scrambled by the RA-RNTI associated with a PRACH occasion corresponding to the PRACH communication transmitted by the UE 802), and (2) the DMRS QCL properties of the PDCCH order do not match DMRS QCL properties of a PDSCH scheduled by the PDCCH associated with the RAR message (e.g., the PDSCH scheduled with the RA-RNTI associated with a PRACH occasion corresponding to the PRACH communication transmitted by the UE 802). Thus, a QCL assumption needs to be defined for a scenario in which CFRA is triggered on the SpCell by the PDCCH order transmitted from the additional PCI 806, and the RAR message is transmitted on the SpCell.

Therefore, in some aspects, the UE 802 may receive the PDCCH order in a CORESET, where an active TCI state of the CORESET is associated with the additional PCI 806, where the PDCCH order triggers the PRACH communication associated with the additional PCI 806, and the additional PCI 806 is configured in the SpCell (e.g., the Pcell of the UE 802 or the PScell of the UE 802). In this scenario, the UE 802 may determine that DMRS QCL properties of the PDCCH order do not match DMRS QCL properties of a PDCCH associated with the RAR message. The UE 802 may further determine that the DMRS QCL properties of the PDCCH order do not match DMRS QCL properties of a PDSCH scheduled by the PDCCH associated with the RAR message. Here, the UE 802 may receive the RAR message based at least in part on an assumption that (1) DMRS QCL properties of a CORESET associated with a Type-1 PDCCH CSS set are to be used for receiving the PDCCH associated with the RAR message, and (2) a QCL assumption of the PDSCH scheduled by the PDCCH associated with the RAR message matches a QCL assumption of the CORESET associated with the Type-1 PDCCH CSS set used for receiving the PDCCH associated with the RAR message.

As indicated above, FIGS. 8A and 8B are provided as examples. Other examples may differ from what is described with respect to FIGS. 8A and 8B.

FIG. 9 is a diagram illustrating an example process 900 performed, for example, by a UE, in accordance with the present disclosure. Example process 900 is an example where the UE (e.g., UE 120, a UE 802, or the like) performs operations associated with TA indication in an RAR for inter-cell multi-TRP communication.

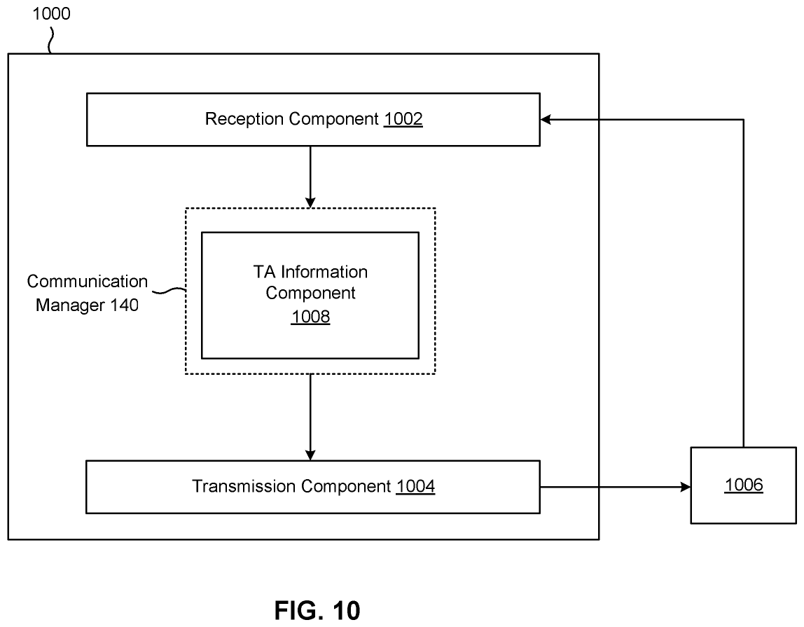

As shown in FIG. 9, in some aspects, process 900 may include transmitting a PRACH communication associated with an additional PCI, the additional PCI being a PCI that is different from a PCI of a serving cell of the UE (block 910). For example, the UE (e.g., using communication manager 140 and/or transmission component 1004, depicted in FIG. 10) may transmit a PRACH communication associated with an additional PCI, the additional PCI being a PCI that is different from a PCI of a serving cell of the UE, as described above.

As further shown in FIG. 9, in some aspects, process 900 may include receiving an RAR message responsive to the PRACH communication associated with the additional PCI, wherein the RAR message indicates TA information associated with the additional PCI (block 920). For example, the UE (e.g., using communication manager 140 and/or reception component 1002, depicted in FIG. 10) may receive an RAR message responsive to the PRACH communication associated with the additional PCI, wherein the RAR message indicates TA information associated with the additional PCI, as described above.

Process 900 may include additional aspects, such as any single aspect or any combination of aspects described below and/or in connection with one or more other processes described elsewhere herein.

In a first aspect, the additional PCI is associated with one or more active TCI states.

In a second aspect, alone or in combination with the first aspect, further comprising applying the TA information in association with transmitting an uplink communication a processing timeline after receiving the RAR message indicating the TA information.

In a third aspect, the additional PCI is not associated with any active TCI state.

In a fourth aspect, alone or in combination with the third aspect, process 900 includes storing the TA information indicated in the RAR message, determining, based at least in part on a TA information window, that the TA information has not expired, and applying the TA information in association with transmitting an uplink communication based at least in part on determining that the TA information has not expired and a determination that that the additional PCI is associated with one or more active TCI states before the TA information expires.

In a fifth aspect, alone or in combination with one or more of the third and fourth aspects, process 900 includes storing the TA information indicated in the RAR message, determining, based at least in part on a TA information window, that the TA information has expired, and dropping the TA information based at least in part on determining that the TA information has expired and a determination that the additional PCI is not associated with any active TCI state before the TA information expires.

In a sixth aspect, alone or in combination with one or more of the first through fifth aspects, process 900 includes selectively dropping the TA information based at least in part on a TA information window.

In a seventh aspect, in combination with the sixth aspect, a start of the TA information window is at an end of the PRACH communication associated with the additional PCI.

In an eighth aspect, in combination with the sixth aspect, a start of the TA information window is at an end of reception of the RAR message.

In a ninth aspect, alone or in combination with one or more of the sixth through eighth aspects, a duration of the TA information window is preconfigured on the UE according to a wireless communication standard.

In a tenth aspect, alone or in combination with one or more of the sixth through ninth aspects, a duration of the TA information window is configured on the UE by a network node.

In an eleventh aspect, alone or in combination with one or more of the first through tenth aspects, process 900 includes transmitting UE capability information indicating at least one of a maximum quantity of items of TA information that can be stored by the UE for a single cell or a maximum quantity of items of TA information that can be stored by the UE for multiple cells.

In a twelfth aspect, alone or in combination with one or more of the first through eleventh aspects, the RAR message is received on a Pcell of the UE or a PScell of the UE.

In a thirteenth aspect, alone or in combination with one or more of the first through twelfth aspects, the RAR message is received based at least in part on performing monitoring during an RAR monitoring window, wherein a start of the RAR monitoring window is at a first symbol of an earliest CORESET that is at least a particular amount of time after an end of a PRACH occasion corresponding to the PRACH communication associated with the additional PCI.

In a fourteenth aspect, in combination with the thirteenth aspect, the particular amount of time corresponds to a particular quantity of symbols, a particular quantity of slots, or a particular quantity of milliseconds.

In a fifteenth aspect, alone or in combination with one or more of the thirteenth and through fourteenth aspects, the particular amount of time is configured per additional PCI.

In a sixteenth aspect, alone or in combination with one or more of the thirteenth through fifteenth aspects, the particular amount of time is associated with multiple additional PCIs.

In a seventeenth aspect, alone or in combination with one or more of the thirteenth through sixteenth aspects, a duration of the RAR monitoring window is configured per additional PCI.

In an eighteenth aspect, alone or in combination with one or more of the first through seventeenth aspects, process 900 includes performing monitoring during both a first RAR monitoring window and a second RAR monitoring window.

In a nineteenth aspect, alone or in combination with one or more of the first through seventeenth aspects, process 900 includes performing monitoring during a first RAR monitoring window, and selectively performing monitoring during a second RAR monitoring window based at least in part on a result of monitoring during the first RAR monitoring window.

In a twentieth aspect, in combination with the nineteenth aspect, selectively performing monitoring during the second RAR monitoring window comprises performing monitoring during the second RAR window based at least in part on a PDCCH communication scrambled by an RA-RNTI associated with a PRACH occasion corresponding to the PRACH communication not being detected during the first RAR monitoring window.

In a twenty-first aspect, in combination with the nineteenth aspect, selectively performing monitoring during the second RAR monitoring window comprises refraining from performing monitoring during the second RAR window based at least in part on a PDCCH communication scrambled by an RA-RNTI associated with a PRACH occasion corresponding to the PRACH communication being detected during the first RAR monitoring window.

In a twenty-second aspect, alone or in combination with one or more of the first through twenty-first aspects, process 900 includes transmitting UE capability information indicating whether monitoring for the RAR message in multiple RAR monitoring windows is supported by the UE.

In a twenty-third aspect, alone or in combination with one or more of the first through twenty-second aspects, process 900 includes receiving a PDCCH order in a CORESET, an active TCI state of the CORESET being associated with the additional PCI, wherein the PDCCH order triggers the PRACH communication associated with the additional PCI, and wherein the additional PCI is configured in a Pcell of the UE or a PScell of the UE, determining that DMRS QCL properties of the PDCCH order do not match DMRS QCL properties of a PDCCH associated with the RAR message, and determining that the DMRS QCL properties of the PDCCH order do not match DMRS QCL properties of a PDSCH scheduled by the PDCCH associated with the RAR message.

In a twenty-fourth aspect, in combination with the twenty-third aspect, the RAR message is received based at least in part on an assumption that DMRS QCL properties of a CORESET associated with a Type-1 PDCCH CSS set are to be used for receiving the PDCCH associated with the RAR message, and a QCL assumption of the PDSCH scheduled by the PDCCH associated with the RAR message matches a QCL assumption of the CORESET associated with the Type-1 PDCCH CSS set used for receiving the PDCCH associated with the RAR message.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a TA information component 1008, among other examples.

In some aspects, the apparatus 1000 may be configured to perform one or more operations described herein in connection with FIGS. 8A and 8B. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The transmission component 1004 may transmit a PRACH communication associated with an additional PCI, the additional PCI being a PCI that is different from a PCI of a serving cell of the UE. The reception component 1002 may receive an RAR message responsive to the PRACH communication associated with the additional PCI wherein the RAR message indicates TA information associated with the additional PCI.

The TA information component 1008 may store the TA information indicated in the RAR message.

The TA information component 1008 may determine, based at least in part on a TA information window, that the TA information has not expired.

The TA information component 1008 may apply the TA information in association with transmitting an uplink communication based at least in part on determining that the TA information has not expired and a determination that that the additional PCI is associated with one or more active TCI states before the TA information expires.

The TA information component 1008 may determine, based at least in part on a TA information window, that the TA information has expired.

The TA information component 1008 may drop the TA information based at least in part on determining that the TA information has expired and a determination that the additional PCI is not associated with any active TCI state before the TA information expires.

The transmission component 1004 may transmit UE capability information indicating at least one of a maximum quantity of items of TA information that can be stored by the UE for a single cell or a maximum quantity of items of TA information that can be stored by the UE for multiple cells.

The reception component 1002 may perform monitoring during both a first RAR monitoring window and a second RAR monitoring window.

The reception component 1002 may perform monitoring during a first RAR monitoring window.

The reception component 1002 may selectively perform monitoring during a second RAR monitoring window based at least in part on a result of monitoring during the first RAR monitoring window.

The transmission component 1004 may transmit UE capability information indicating whether monitoring for the RAR message in multiple RAR monitoring windows is supported by the UE.

The reception component 1002 may receive a PDCCH order in a CORESET, an active TCI state of the CORESET being associated with the additional PCI wherein the PDCCH order triggers the PRACH communication associated with the additional PCI, and wherein the additional PCI is configured in a Pcell of the UE or a PScell of the UE.

The reception component 1002 may determine that DMRS QCL properties of the PDCCH order do not match DMRS QCL properties of a PDCCH associated with the RAR message.

The reception component 1002 may determine that the DMRS QCL properties of the PDCCH order do not match DMRS QCL properties of a PDSCH scheduled by the PDCCH associated with the RAR message.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: transmitting a PRACH communication associated with an additional PCI, the additional PCI being a PCI that is different from a PCI of a serving cell of the UE; and receiving an RAR message responsive to the PRACH communication associated with the additional PCI, wherein the RAR message indicates TA information associated with the additional PCI.

Aspect 2: The method of Aspect 1, wherein the additional PCI is associated with one or more active TCI states.

Aspect 3: The method of Aspect 1, wherein further comprising applying the TA information in association with transmitting an uplink communication a processing timeline after receiving the RAR message indicating the TA information.

Aspect 4: The method of Aspect 1, wherein the additional PCI is not associated with any active TCI state.

Aspect 5: The method of Aspect 1, further comprising: storing the TA information indicated in the RAR message; determining, based at least in part on a TA information window, that the TA information has not expired; and applying the TA information in association with transmitting an uplink communication based at least in part on determining that the TA information has not expired and a determination that that the additional PCI is associated with one or more active TCI states before the TA information expires.

Aspect 6: The method of Aspect 1, further comprising: storing the TA information indicated in the RAR message; determining, based at least in part on a TA information window, that the TA information has expired; and dropping the TA information based at least in part on determining that the TA information has expired and a determination that the additional PCI is not associated with any active TCI state before the TA information expires.

Aspect 7: The method of Aspect 1, further comprising selectively dropping the TA information based at least in part on a TA information window.

Aspect 8: The method of Aspect 7, wherein a start of the TA information window is at an end of the PRACH communication associated with the additional PCI.

Aspect 9: The method of Aspect 7, wherein a start of the TA information window is at an end of reception of the RAR message.

Aspect 10: The method of Aspect 7, wherein a duration of the TA information window is preconfigured on the UE according to a wireless communication standard.

Aspect 11: The method of Aspect 7, wherein a duration of the TA information window is configured on the UE by a network node.

Aspect 12: The method of Aspect 1, further comprising transmitting UE capability information indicating at least one of a maximum quantity of items of TA information that can be stored by the UE for a single cell or a maximum quantity of items of TA information that can be stored by the UE for multiple cells.

Aspect 13: The method of Aspect 1, wherein the RAR message is received on a Pcell of the UE or a PScell of the UE.

Aspect 14: The method of Aspect 1, wherein the RAR message is received based at least in part on performing monitoring during an RAR monitoring window, wherein a start of the RAR monitoring window is at a first symbol of an earliest CORESET that is at least a particular amount of time after an end of a PRACH occasion corresponding to the PRACH communication associated with the additional PCI.

Aspect 15: The method of Aspect 14, wherein the particular amount of time corresponds to a particular quantity of symbols, a particular quantity of slots, or a particular quantity of milliseconds.

Aspect 16: The method of Aspect 14, wherein the particular amount of time is configured per additional PCI.

Aspect 17: The method of Aspect 14, wherein the particular amount of time is associated with multiple additional PCIs.

Aspect 18: The method of Aspect 14, wherein a duration of the RAR monitoring window is configured per additional PCI.

Aspect 19: The method of Aspect 1, further comprising performing monitoring during both a first RAR monitoring window and a second RAR monitoring window.

Aspect 20: The method of Aspect 1, further comprising: performing monitoring during a first RAR monitoring window; and selectively performing monitoring during a second RAR monitoring window based at least in part on a result of monitoring during the first RAR monitoring window.

Aspect 21: The method of Aspect 20, wherein selectively performing monitoring during the second RAR monitoring window comprises: performing monitoring during the second RAR window based at least in part on a PDCCH communication scrambled by an RA-RNTI associated with a PRACH occasion corresponding to the PRACH communication not being detected during the first RAR monitoring window.

Aspect 22: The method of Aspect 20, wherein selectively performing monitoring during the second RAR monitoring window comprises: refraining from performing monitoring during the second RAR window based at least in part on a PDCCH communication scrambled by an RA-RNTI associated with a PRACH occasion corresponding to the PRACH communication being detected during the first RAR monitoring window.

Aspect 23: The method of Aspect 1, further comprising transmitting UE capability information indicating whether monitoring for the RAR message in multiple RAR monitoring windows is supported by the UE.

Aspect 24: The method of Aspect 1, further comprising: receiving a PDCCH order in a CORESET, an active TCI state of the CORESET being associated with the additional PCI, wherein the PDCCH order triggers the PRACH communication associated with the additional PCI, and wherein the additional PCI is configured in a Pcell of the UE or a PScell of the UE; determining that DMRS QCL properties of the PDCCH order do not match DMRS QCL properties of a PDCCH associated with the RAR message; and determining that the DMRS QCL properties of the PDCCH order do not match DMRS QCL properties of a PDSCH scheduled by the PDCCH associated with the RAR message.

Aspect 25: The method of Aspect 24, wherein the RAR message is received based at least in part on an assumption that: DMRS QCL properties of a CORESET associated with a Type-1 PDCCH CYCLIC SHIFTS set are to be used for receiving the PDCCH associated with the RAR message; and a QCL assumption of the PDSCH scheduled by the PDCCH associated with the RAR message matches a QCL assumption of the CORESET associated with the Type-1 PDCCH CSS set used for receiving the PDCCH associated with the RAR message.

Aspect 26: An apparatus for wireless communication at a device, comprising a processor; memory coupled with the processor, and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-25.

Aspect 28: An apparatus for wireless communication, comprising at least one means for performing the method of one or more of Aspects 1-25.

Aspect 29: A non-transitory computer-readable medium storing code for wireless communication, the code comprising instructions executable by a processor to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit a physical random access channel (PRACH) communication associated with an additional physical cell identifier (PCI), the additional PCI being a PCI that is different from a PCI of a serving cell of the UE; and
receive a random access response (RAR) message responsive to the PRACH communication associated with the additional PCI,
wherein the RAR message indicates timing advance (TA) information associated with the additional PCI.

2. The UE of claim 1, wherein the additional PCI is associated with one or more active transmission configuration indicator (TCI) states.

3. The UE of claim 1, wherein further comprising applying the TA information in association with transmitting an uplink communication a processing timeline after receiving the RAR message indicating the TA information.

4. The UE of claim 1, wherein the additional PCI is not associated with any active transmission configuration indicator (TCI) state.

5. The UE of claim 1, wherein the one or more processors are further configured to:
store the TA information indicated in the RAR message;
determine, based at least in part on a TA information window, that the TA information has not expired; and
apply the TA information in association with transmitting an uplink communication based at least in part on determining that the TA information has not expired and a determination that that the additional PCI is associated with one or more active transmission configuration indicator (TCI) states before the TA information expires.

6. The UE of claim 1, wherein the one or more processors are further configured to:
store the TA information indicated in the RAR message;
determine, based at least in part on a TA information window, that the TA information has expired; and
drop the TA information based at least in part on determining that the TA information has expired and a determination that the additional PCI is not associated with any active transmission configuration indicator (TCI) state before the TA information expires.

7. The UE of claim 1, wherein the one or more processors are further configured to selectively drop the TA information based at least in part on a TA information window.

8. The UE of claim 7, wherein a start of the TA information window is at an end of the PRACH communication associated with the additional PCI.

9. The UE of claim 7, wherein a start of the TA information window is at an end of reception of the RAR message.

10. The UE of claim 7, wherein a duration of the TA information window is preconfigured on the UE according to a wireless communication standard.

11. The UE of claim 7, wherein a duration of the TA information window is configured on the UE by a network node.

12. The UE of claim 1, wherein the one or more processors are further configured to transmit UE capability information indicating at least one of a maximum quantity of items of TA information that can be stored by the UE for a single cell or a maximum quantity of items of TA information that can be stored by the UE for multiple cells.

13. The UE of claim 1, wherein the RAR message is received on a primary cell (Pcell) of the UE or a primary secondary cell (PScell) of the UE.

14. The UE of claim 1, wherein the RAR message is received based at least in part on performing monitoring during an RAR monitoring window, wherein a start of the RAR monitoring window is at a first symbol of an earliest control resource set (CORESET) that is at least a particular amount of time after an end of a PRACH occasion corresponding to the PRACH communication associated with the additional PCI.

15. The UE of claim 14, wherein the particular amount of time corresponds to a particular quantity of symbols, a particular quantity of slots, or a particular quantity of milliseconds.

16. The UE of claim 14, wherein the particular amount of time is configured per additional PCI.

17. The UE of claim 14, wherein the particular amount of time is associated with multiple additional PCIs.

18. The UE of claim 14, wherein a duration of the RAR monitoring window is configured per additional PCI.

19. The UE of claim 1, wherein the one or more processors are further configured to perform monitoring during both a first RAR monitoring window and a second RAR monitoring window.

20. The UE of claim 1, wherein the one or more processors are further configured to:
perform monitoring during a first RAR monitoring window; and
selectively perform monitoring during a second RAR monitoring window based at least in part on a result of monitoring during the first RAR monitoring window.

21. The UE of claim 20, wherein the one or more processors, to selectively perform monitoring during the second RAR monitoring window, are configured to:
perform monitoring during the second RAR window based at least in part on a physical downlink control channel (PDCCH) communication scrambled by a random access radio network temporary identifier (RA-RNTI) associated with a PRACH occasion corresponding to the PRACH communication not being detected during the first RAR monitoring window.

22. The UE of claim 20, wherein the one or more processors, to selectively perform monitoring during the second RAR monitoring window, are configured to:
refrain from performing monitoring during the second RAR window based at least in part on a physical downlink control channel (PDCCH) communication scrambled by a random access radio network temporary identifier (RA-RNTI) associated with a PRACH occasion corresponding to the PRACH communication being detected during the first RAR monitoring window.

23. The UE of claim 1, wherein the one or more processors are further configured to transmit UE capability information indicating whether monitoring for the RAR message in multiple RAR monitoring windows is supported by the UE.

24. The UE of claim 1, wherein the one or more processors are further configured to:
receive a physical downlink control channel (PDCCH) order in a control resource set (CORESET), an active transmission configuration indicator (TCI) state of the CORESET being associated with the additional PCI,
wherein the PDCCH order triggers the PRACH communication associated with the additional PCI, and
wherein the additional PCI is configured in a primary cell (Pcell) of the UE or a primary secondary cell (PScell) of the UE;
determine that demodulation reference signal (DMRS) quasi co-location (QCL) properties of the PDCCH order do not match DMRS QCL properties of a PDCCH associated with the RAR message; and
determine that the DMRS QCL properties of the PDCCH order do not match DMRS QCL properties of a physical downlink shared channel (PDSCH) scheduled by the PDCCH associated with the RAR message.

25. The UE of claim 24, wherein the RAR message is received based at least in part on an assumption that:
DMRS QCL properties of a CORESET associated with a Type-1 PDCCH common search space (CSS) set are to be used for receiving the PDCCH associated with the RAR message; and
a QCL assumption of the PDSCH scheduled by the PDCCH associated with the RAR message matches a QCL assumption of the CORESET associated with the Type-1 PDCCH CSS set used for receiving the PDCCH associated with the RAR message.

26. A method of wireless communication performed by a user equipment (UE), comprising:
transmitting a physical random access channel (PRACH) communication associated with an additional physical cell identifier (PCI), the additional PCI being a PCI that is different from a PCI of a serving cell of the UE; and
receiving a random access response (RAR) message responsive to the PRACH communication associated with the additional PCI,
wherein the RAR message indicates timing advance (TA) information associated with the additional PCI.

27. The method of claim 26, wherein the additional PCI is associated with one or more active transmission configuration indicator (TCI) states.

28. The method of claim 26, wherein further comprising applying the TA information in association with transmitting an uplink communication a processing timeline after receiving the RAR message indicating the TA information.

29. The method of claim 26, wherein the additional PCI is not associated with any active transmission configuration indicator (TCI) state.

30. The method of claim 26, further comprising:
storing the TA information indicated in the RAR message;
determining, based at least in part on a TA information window, that the TA information has not expired; and
applying the TA information in association with transmitting an uplink communication based at least in part on determining that the TA information has not expired and a determination that that the additional PCI is associated with one or more active transmission configuration indicator (TCI) states before the TA information expires.

31. The method of claim 26, further comprising:
storing the TA information indicated in the RAR message;
determining, based at least in part on a TA information window, that the TA information has expired; and
dropping the TA information based at least in part on determining that the TA information has expired and a determination that the additional PCI is not associated with any active transmission configuration indicator (TCI) state before the TA information expires.

32. The method of claim 26, further comprising selectively dropping the TA information based at least in part on a TA information window.

33. The method of claim 26, further comprising transmitting UE capability information indicating at least one of a maximum quantity of items of TA information that can be stored by the UE for a single cell or a maximum quantity of items of TA information that can be stored by the UE for multiple cells.

34. A non-transitory computer-readable medium storing a set of instructions for wireless communication, the set of instructions comprising:
one or more instructions that, when executed by one or more processors of a user equipment (UE), cause the UE to:
transmit a physical random access channel (PRACH) communication associated with an additional physical cell identifier (PCI), the additional PCI being a PCI that is different from a PCI of a serving cell of the UE; and
receive a random access response (RAR) message responsive to the PRACH communication associated with the additional PCI,
wherein the RAR message indicates timing advance (TA) information associated with the additional PCI.

35. An apparatus for wireless communication, comprising:
means for transmitting a physical random access channel (PRACH) communication associated with an additional physical cell identifier (PCI), the additional PCI being a PCI that is different from a PCI of a serving cell of the apparatus; and
means for receiving a random access response (RAR) message responsive to the PRACH communication associated with the additional PCI,
wherein the RAR message indicates timing advance (TA) information associated with the additional PCI.
